(19) United States
(12) Patent Application Publication
(10) Pub. No.: US 2026/0212040 A1
(43) Pub. Date: Jul. 23, 2026

(54) BIOMETRIC RECOGNITION USING MASK-BASED GENERATION OF RESIDUAL IMAGES

(71) Applicant: Dell Products L.P., Round Rock, TX (US)

(72) Inventors: Min Gong, Shanghai (CN); Deepaganesh Paulraj, Bangalore (IN); Zijia Wang, London (GB)

(21) Appl. No.: 19/032,670

(22) Filed: Jan. 21, 2025

(51) Int. Cl. G06F 21/62; G06F 21/32; G06T 5/20

(52) U.S. Cl. CPC G06F 21/6245; G06F 21/32; G06T 5/20

(57) ABSTRACT

Techniques are provided for biometric recognition using mask-based generation of residual images. One method comprises encoding at least a portion of at least one image of a user to obtain a multi-dimensional representation of the image; generating at least one mask identifying one or more sub-regions of the image; generating a residual image utilizing a transformation function that processes the multi-dimensional representation of the image, the mask and at least one noise vector; applying the residual image to a recognition model to determine a recognition result; and controlling a performance of at least one automated action based at least in part on the recognition result. The transformation function may determine a difference between the multi-dimensional representation of the image within the one or more sub-regions identified by the mask and at least a portion of the at least one noise vector.

### BACKGROUND

Biometric authentication techniques use one or more biological characteristics of a user to verify an identity of the user. Traditional face recognition systems, for example, may suffer from one or more vulnerabilities that allow sensitive user facial characteristics to be recovered.

### SUMMARY

Illustrative embodiments of the disclosure provide techniques for biometric recognition using mask-based generation of residual images. One method includes encoding at least a portion of at least one image of a user to obtain a multi-dimensional representation of the image; generating at least one mask identifying one or more sub-regions of the image; generating a residual image utilizing a transformation function that processes the multi-dimensional representation of the image, the mask and at least one noise vector; applying the residual image to a recognition model to determine a recognition result; and controlling a performance of at least one automated action based at least in part on the recognition result.

Illustrative embodiments can provide significant advantages relative to conventional techniques. For example, technical problems related to such conventional techniques are mitigated in one or more embodiments by employing a transformation function that determines a residual image for biometric recognition using a mask and a noise vector.

These and other illustrative embodiments described herein include, without limitation, methods, apparatus, systems, and computer program products comprising processor-readable storage media.

### BRIEF DESCRIPTION OF THE DRAWINGS

FIG. 1 illustrates an information processing system configured for biometric recognition using mask-based generation of residual images in accordance with an illustrative embodiment;

FIG. 2 is a flow diagram illustrating an exemplary implementation of a process for privacy-preserving face recognition in accordance with an illustrative embodiment;

FIGS. 3 and 4 are flow diagrams illustrating exemplary implementations of processes for biometric recognition using mask-based generation of residual images in accordance with illustrative embodiments;

FIG. 5 is a flow diagram illustrating an exemplary implementation of a process for improving performance of a privacy-preserving biometric recognition platform in accordance with an illustrative embodiment;

FIG. 6 is a flow diagram illustrating an exemplary implementation of a process for biometric recognition using mask-based generation of residual images in accordance with an illustrative embodiment;

FIG. 7 illustrates an exemplary processing platform that may be used to implement at least a portion of one or more embodiments of the disclosure comprising a cloud infrastructure; and

FIG. 8 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for biometric recognition using mask-based generation of residual images.

Traditional biometric recognition systems, such as facial recognition systems, may expose sensitive user information to unauthorized decryption and/or recovery. In one or more embodiments, the disclosed techniques for biometric recognition using mask-based generation of residual images preserve identity features within a high-dimensional feature space, ensuring high recognition accuracy, while making it difficult to decrypt and/or recover the underlying biometric features (thereby maintaining the privacy of facial images, for example). The mask-based image subtraction techniques maintain the ability to recognize facial features, for example, by authorized systems, while preventing attackers from decrypting and/or recovering the underlying biometric features from the protected image representations. In this manner, robust mask-based image subtraction techniques are provided that reduce unauthorized recovery attacks, while maintaining the security of biometric images (e.g., facial images).

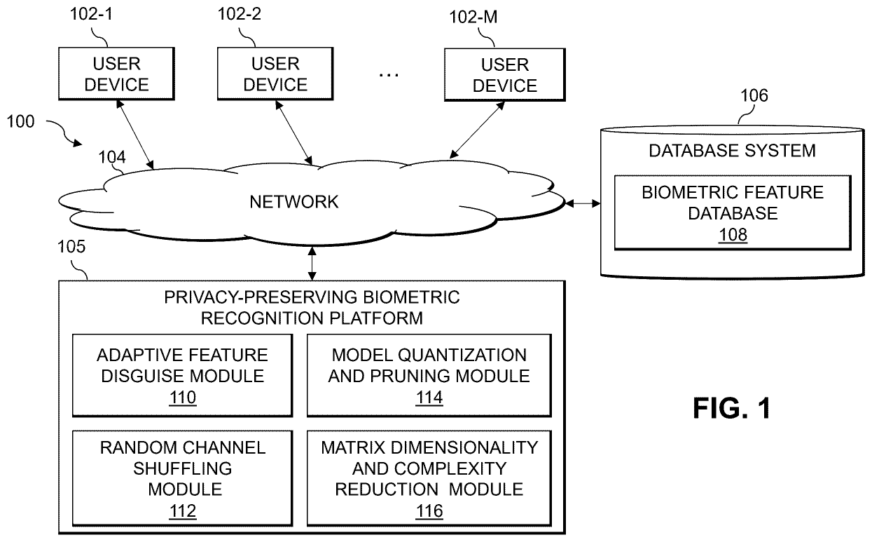

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a privacy-preserving biometric recognition platform 105 and a database system 106.

The user devices 102 may comprise, for example, devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

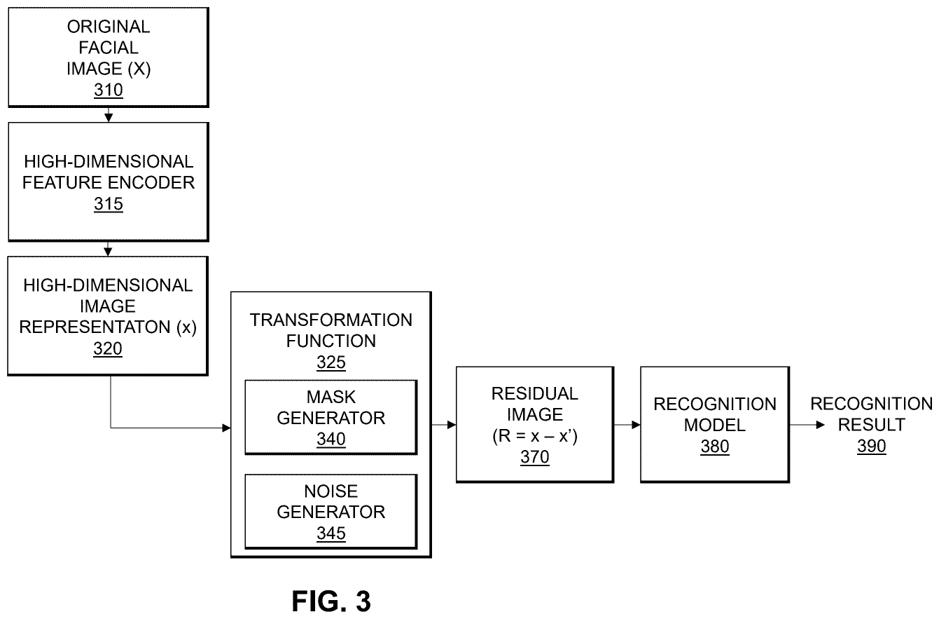

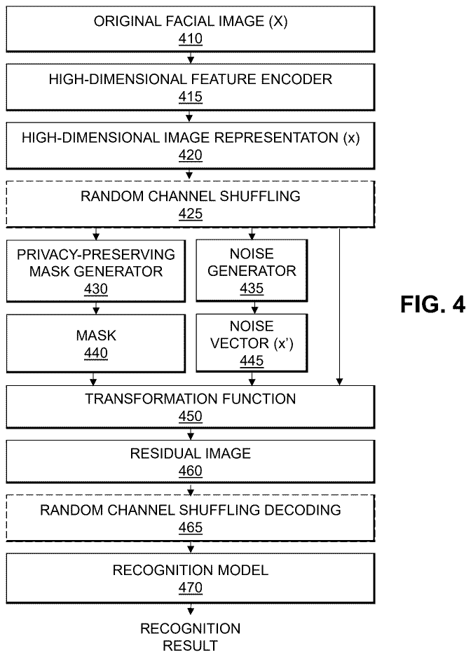

The privacy-preserving biometric recognition platform 105 may comprise an adaptive feature disguise module 110, a random channel shuffling module 112, a model quantization and pruning module 114 and a matrix dimensionality and complexity reduction module 116. The adaptive feature disguise module 110, in some embodiments, may dynamically adjust high-dimensional data to enhance privacy, as discussed further below in conjunction with FIGS. 3 and 4, for example. In at least some embodiments, the random channel shuffling module 112 incorporates random channel shuffling to introduce unpredictability in the image data (thereby hindering potential recovery efforts by unauthorized entities, for example), as discussed further below in conjunction with FIG. 4, for example.

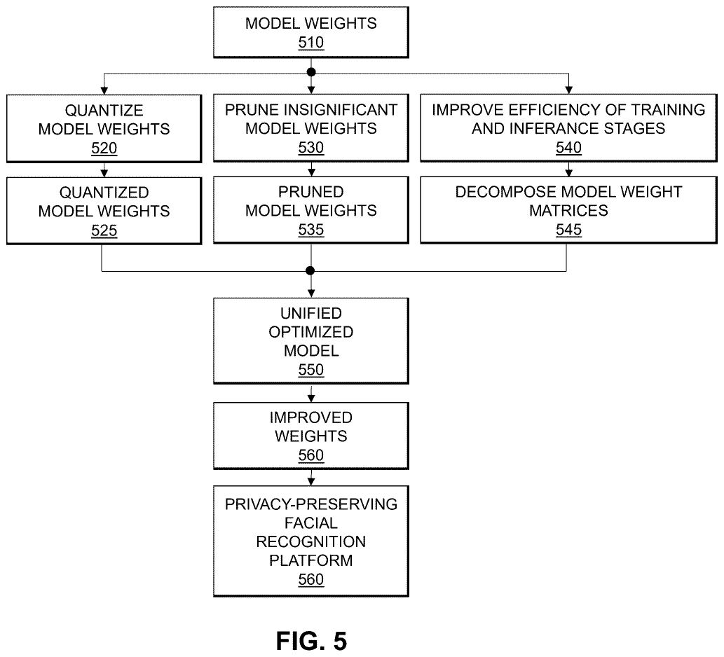

In one or more embodiments, the model quantization and pruning module 114 may improve a performance of the privacy-preserving biometric recognition platform 105 by quantizing and/or pruning one or more model weights employed by the privacy-preserving biometric recognition platform 105, as discussed further below in conjunction with FIG. 5, for example. The matrix dimensionality and complexity reduction module 116 may improve a performance of the privacy-preserving biometric recognition platform 105 by reducing a complexity of matrix multiplications and/or a dimensionality of one or more matrices employed by the privacy-preserving biometric recognition platform 105.

Exemplary processes utilizing elements 110, 112, 114 and/or 116 will be described in more detail with reference to, for example, FIGS. 3 through 5.

It is to be appreciated that this particular arrangement of elements 110, 112, 114 and/or 116 illustrated in the privacy-preserving biometric recognition platform 105 of the FIG. 1 embodiment is presented by way of example only, and alternative arrangements can be used in other embodiments. For example, the functionality associated with the elements 110, 112, 114 and/or 116 in other embodiments can be combined into a single module, or separated across a larger number of modules. As another example, multiple distinct processors can be used to implement different ones of the elements 110, 112, 114 and/or 116 or portions thereof.

At least portions of elements 110, 112, 114 and/or 116 may be implemented at least in part in the form of software that is stored in memory and executed by a processor.

Additionally, the database system 106 may comprise one or more databases, such as a biometric feature database 108 (e.g., comprising information characterizing facial features or other features extracted from images). The database 108 may be configured to store data, for example, in tables, in a known manner. While the database 108 are illustrated in FIG. 1 as comprising distinct databases, at least portions of the database 108 may be implemented using a single database (e.g., different parts of a single database). Example database 108, such as depicted in the present embodiment, can be implemented using one or more storage systems associated with the privacy-preserving biometric recognition platform 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the privacy-preserving biometric recognition platform 105 are one or more input-output devices, which illustratively comprise keyboards, displays or other types of input-output devices in any combination. Such input-output devices can be used, for example, to support one or more user interfaces to the privacy-preserving biometric recognition platform 105, as well as to support communication between privacy-preserving biometric recognition platform 105 and other related systems and devices not explicitly shown.

Additionally, the privacy-preserving biometric recognition platform 105 in the FIG. 1 embodiment is assumed to be implemented using at least one processing device. Each such processing device generally comprises at least one processor and an associated memory, and implements one or more functional modules for controlling certain features of the privacy-preserving biometric recognition platform 105.

More particularly, the privacy-preserving biometric recognition platform 105 in this embodiment can comprise a processor coupled to a memory and a network interface.

The processor illustratively comprises a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the privacy-preserving biometric recognition platform 105 to communicate over the network 104 with the user devices 102, and illustratively comprises one or more conventional transceivers.

It is to be understood that the particular set of elements shown in FIG. 1 for the privacy-preserving biometric recognition platform 105 involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the privacy-preserving biometric recognition platform 105 and at least portions of the database system 106 can be on and/or part of the same processing platform.

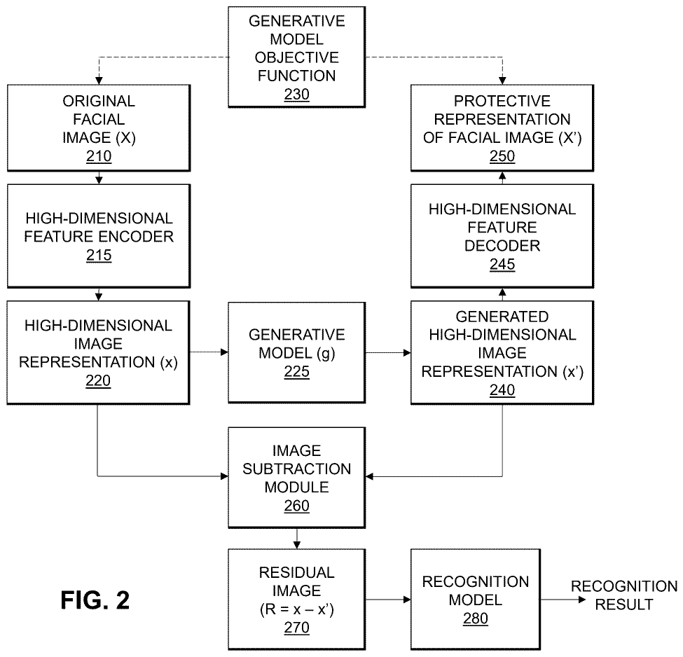

FIG. 2 is a flow diagram illustrating an exemplary implementation of a process for privacy-preserving face recognition in accordance with an illustrative embodiment. Privacy-preserving face recognition techniques generate protective face representations by capturing a residue between an original face image, X, and a regeneration, X′, of the original face image. Privacy-preserving face recognition techniques ensure recognizability and privacy of the residue through high-dimensional mapping and random channel shuffling.

In the example of FIG. 2, an original facial image, X, 210 is applied to a high-dimensional feature encoder 215 that encodes the original facial image 210 into a high-dimensional image representation, x, 220. The high-dimensional image representation 220 is applied to a generative model, g, 225 that generates a generated high-dimensional image representation, x′, 240. The generative model 225 is trained to regenerate a facial image, X′, from the original facial image, X. An objective function 230 of the generative model 225 may be expressed as follows:

$${L}_{gen} = {‖ X , {X}^{′} ‖}_{1} . \qquad ( 1 )$$

The generated high-dimensional image representation 240 may be applied to a high-dimensional feature decoder 245 that generates a protective representation, X′, 250 of the original facial image 210.

An image subtraction module 260 determines a difference between the high-dimensional image representation 220 and the generated high-dimensional image representation 240 to obtain a residual image (R=x−x′) 270. In this manner, the image subtraction module 260 creates a visually uninformative facial image through feature subtraction between the original facial image 210 and the model-produced representation 240. The difference may be determined, for example, using a subtraction mathematical function or other mathematical functions that determine a difference, and/or combinations of such functions, some of which may involve subtraction.

In one or more embodiments, the residual image 270 may be optimized with a recognition model 280 to preserve identity features, for example, by co-training the recognition model on the high-dimensional feature representations generated by the generative model 225. The recognition model 280 processes the residual image 270 to determine a recognition result.

The flow diagram of FIG. 2 is based at least in part on facial recognition techniques described in Y. Mi et al., “Privacy-Preserving Face Recognition Using Trainable Feature Subtraction,” 2024 Conference on Computer Vision and Pattern Recognition (March 2024), incorporated by reference herein in its entirety. One or more aspects of the facial recognition techniques described in conjunction with FIG. 2 are inspired by image compression techniques to subtract features from an original facial image to produce a visually uninformative variation of the original facial image (to balance the need to maintain privacy while also ensuring the effectiveness of the facial recognition techniques).

FIG. 3 is a flow diagram illustrating an exemplary implementation of a process for biometric recognition using mask-based generation of residual images in accordance with an illustrative embodiment. In the example of FIG. 3, an original facial image, X, 310 is applied to a high-dimensional feature encoder 315 that generates a high-dimensional image representation, x, 320. The high-dimensional image representation 320 is applied to a transformation function 325 that comprises a mask generator 340 and a noise generator 345. The noise generator 345 generates a noise vector, as discussed further below in conjunction with FIG. 4, that serves as a high-dimensional image representation, such as the generated high-dimensional image representation 240 of FIG. 2.

The transformation function 325 generates a residual image (R=x-x′) 370. The residual image 370 comprises a visually uninformative facial image through feature subtraction between portions, determined in accordance with the mask generated by the mask generator 340, of the original facial image 310 and the noise vector generated by the noise generator 345.

In one or more embodiments, the residual image 370 may be optimized with a recognition model 380 to preserve identity features, for example, by training the recognition model 380 on the noise vectors generated by the noise generator 345. The recognition model 380 processes the residual image 370 to determine a recognition result.

FIG. 4 is a flow diagram illustrating an exemplary implementation of a process for biometric recognition using mask-based generation of residual images in accordance with an illustrative embodiment. In the example of FIG. 4, an original facial image, X, 410 is applied to a high-dimensional feature encoder 415 that generates a high-dimensional image representation, x, 420. The high-dimensional image representation 420 may be applied to an optional random channel shuffling stage 425

The random channel shuffling stage 425 enhances privacy by introducing randomness into an ordering of the red, green and blue (RGB) channels of the high-dimensional data, making unauthorized recovery significantly more challenging. The random channel shuffling stage 425 may employ a shuffling function that operates on the RGB channels of each pixel. For a pixel p with RGB values (r, g, b), the shuffled values may be expressed in some embodiments as follows:

$$( {r}_{Δ} , {g}_{Δ} , {b}_{Δ} ) = s ( r , g , b ; θ ) \qquad ( 2 )$$

where θ is a permutation configuration dynamically selected for each session using a pseudorandom generator, as follows:

$$θ = RandomPermutation ( [ 1 , 2 , 3 ] ) . \qquad ( 3 )$$

The dynamic randomness (e.g., dynamically altered channel arrangements) introduced by the random channel shuffling stage 425 ensures that the RGB channels are unpredictably rearranged in order to provide robust privacy protection, while preserving recognition capabilities.

An output of the random channel shuffling stage 425 is applied to a privacy-preserving mask generator 430 and a noise generator 435, as well as to a transformation function 450.

The privacy-preserving mask generator 430 generates a mask 440 that determines portions of the original facial image 410 where feature subtraction techniques are applied. In this manner, the larger the size of the mask 440, the greater that the privacy is preserved in the original facial image 410 (e.g., by increasing the proportion of randomized image features). The noise generator 435 generates a noise vector, x′, 445.

The privacy-preserving mask generator 430 may be trained in some embodiments to generate a mask 440 that maximizes an entropy of the disguised image features, thus ensuring privacy. An objective function of the privacy-preserving mask generator 430 may be expressed in some embodiments as follows:

$${L}_{privacy} = - {\sum }_{i} p ( {x}_{i} ) log p ( {x}_{i} ) \qquad ( 4 )$$

where p(xᵢ) is the probability distribution of the i-th feature in the disguised image representation.

In one or more embodiments, the transformation function 450 processes the mask 440 and the noise vector 445, in accordance with the following equation:

$$T ( x ) = x ⊙ m + ( 1 - m ) ⊙ {x}^{′} , \qquad ( 5 )$$

where x is the high-dimensional representation of the original facial image 410, m is the mask 440 generated by the privacy-preserving mask generator 430 and x′ is the noise vector 445 generated by the noise generator 435 that adds randomness to the image features. In this manner, an image subtraction is performed between the original facial image 410 and the noise vector 445 only within the masked regions. In some embodiments, the original facial image 410, the mask 440 and the noise vector 445 are represented as pixel-level matrices.

The transformation function 450 generates a residual image 460 based on the image subtraction between the original facial image 410 and the noise vector 445 within the masked regions.

The residual image 460 is applied to an optional random channel shuffling decoding stage 465 that may be applied when the random channel shuffling stage 425 is applied, as discussed above. To restore the original RGB channel order during recognition, an inverse shuffle may be applied, as follows, to maintain the usability of the shuffled representation for facial recognition:

$${s}^{- 1} ( {r}_{Δ} , {g}_{Δ} , {b}_{Δ} ; θ ) = ( r , g , b ) . \qquad ( 6 )$$

The residual image 460, or the output of the random channel shuffling decoding stage 465, if random channel shuffling is applied in step 425, is applied to a recognition model 470 that processes the residual image 460 to determine a recognition result, in a similar manner as described above in conjunction with FIGS. 2 and 3.

FIG. 5 is a flow diagram illustrating an exemplary implementation of a process for improving performance of a privacy-preserving biometric recognition platform in accordance with an illustrative embodiment. In the example of FIG. 5, model weights 510 are applied in parallel, for example, to three different processing paths. In step 520, the model weights 510 are quantized to produce quantized model weights 525. Quantization techniques may be applied in step 525 to reduce a memory footprint of the recognition model (e.g., recognition model 470) and/or the privacy-preserving model (e.g., employed by the privacy-preserving mask generator 430) by representing weights and activations of the respective mode with reduced precision (e.g., using 8-bit integers instead of 32-bit floating-point numbers).

The quantized weights W_{q} may be expressed in some embodiments as follows:

$${W}_{q} = Q ( W ) = round ( \frac{W - min ( W )}{max ( W ) - min ( W )} x {2}^{b} - 1 ) , \qquad ( 7 )$$

where b is the bit-width (e.g., 8 bits for an 8-bit quantization), Q(·) represents the quantization function, max(W) denotes the maximum value in the weight matrix W (ensuring that the highest value in the matrix maps to the maximum possible integer) and min(W) denotes the minimum value in the weight matrix W (ensuring that the lowest value in the matrix maps to the minimum possible integer). The transformation of equation (7) scales and rounds the model weights to fit within the desired bit-width range, reducing memory usage.

In step 530, insignificant model weights 510 of the recognition model (e.g., recognition model 470) and/or the privacy-preserving model (e.g., employed by the privacy-preserving mask generator 430) are pruned to produce pruned model weights 535. The pruning of step 530 removes unnecessary connections in a model network, resulting in a more compact neural network. The pruning process, in some embodiments, identifies weights below a significance threshold δ and sets them to zero, effectively reducing the model size and computational load.

The pruned weight matrix Wₚ can be defined in some embodiments as:

$${W}_{p} = W \cdot M , \qquad ( 8 )$$

where M is a binary mask matrix, where Mᵢⱼ=1 if |Wᵢⱼ|≥δ and Mᵢⱼ=0 otherwise.

An overall training objective may be expressed as follows:

$${L}_{opt} = γ \cdot {L}_{fr} + δ \cdot {L}_{quant} + ϵ \cdot {L}_{prune} \qquad ( 9 )$$

where γ, δ and ϵ are weighting factors to balance the three objectives.

In step 540, the efficiency of the training and inference stages are improved and in step 545, one or more model weight matrices are decomposed, as discussed below. During an inference stage, for example, a forward pass may be optimized by leveraging low-rank approximations to reduce the complexity of matrix multiplications. For a weight matrix W, Singular Value Decomposition (SVD) may be used to decompose it into three matrices, as follows:

$$W \approx U \sum {V}^{T} , \qquad ( 10 )$$

where U and V are orthogonal matrices, and Σ is a diagonal matrix. By retaining only the most significant components of Σ, the dimensionality and computational requirements can be reduced.

In addition, matrix multiplications may be optimized in some embodiments by employing efficient algorithms (e.g., the Winograd and/or Strassen methods for matrix multiplication) that reduce the computational complexity (e.g., in the high-dimensional layers of the facial recognition pipeline). The optimization of the matrix multiplications may provide a significant reduction in inference time while maintaining recognition accuracy.

The quantized model weights 525, pruned model weights 535 and/or the outputs of steps 540 and/or 545 are aggregated into a unified optimized model 550 having improved weights 560 that are applied to a privacy-preserving facial recognition platform 560.

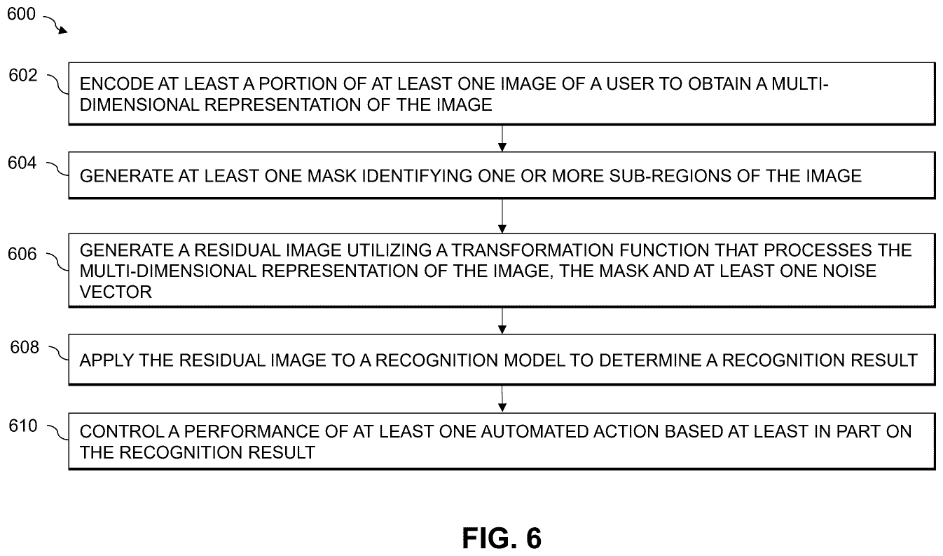

FIG. 6 is a flow diagram illustrating an exemplary implementation of a process 600 for biometric recognition using mask-based generation of residual images in accordance with an illustrative embodiment. In the example of FIG. 6, at least a portion of at least one image is encoded in step 602 to obtain a multi-dimensional representation of the image. At least one mask is generated in step 604 identifying one or more sub-regions of the image. The image may comprise multiple images and/or multiple portions of one or more of the multiple images.

In step 606, a residual image is generated utilizing a transformation function that processes the multi-dimensional representation of the image, the mask and at least one noise vector. The residual image may be applied in step 608 to a recognition model to determine a recognition result. A performance of at least one automated action may be controlled in step 610 based at least in part on the recognition result.

In at least one embodiment, the transformation function determines a difference between the multi-dimensional representation of the image within the one or more sub-regions, identified by the mask, and at least a portion of the at least one noise vector.

In one or more embodiments, the multi-dimensional representation of the image comprises a plurality of pixels, wherein each comprises a plurality of channels (e.g., RGB channels), and further comprising adjusting an order of the plurality of channels prior to applying the multi-dimensional representation of the image to the transformation function. The adjusting the order of the plurality of channels may be based at least in part on a permutation value that is dynamically selected for each user session. An order of the plurality of channels may be restored prior to the applying the residual image to the recognition model.

In some embodiments, the mask is generated using a privacy-preserving model that increases an entropy of the one or more sub-regions of the image. A number of bits used to encode one or more model weights of the recognition model and/or the privacy-preserving model (e.g., when the privacy-preserving model executes on one or more edge nodes) may be reduced. One or more model weights, having a significance value below a designated threshold value (e.g., & from equations 8 and/or 9), of one or more of the recognition model and the privacy-preserving model may be pruned. At least one model weight matrix, of one or more of the recognition model and the privacy-preserving model, may be decomposed into a plurality of sub-matrices, wherein the plurality of sub-matrices comprises a diagonal matrix, and a dimensionality of the diagonal matrix may be reduced by removing one or more model weights from the diagonal matrix. At least one matrix multiplication may be performed using at least one algorithm, of a plurality of algorithms, having a reduced computational complexity, relative to at least one additional algorithm in the plurality of algorithms, by performing a reduced number of the matrix operations.

The particular processing operations and other network functionality described in conjunction with FIGS. 3 through 6, for example, are presented by way of illustrative example only, and should not be construed as limiting the scope of the disclosure in any way. Alternative embodiments can use other types of processing operations for biometric recognition using mask-based generation of residual images. For example, the ordering of the process steps may be varied in other embodiments, or certain steps may be performed concurrently with one another rather than serially. In one aspect, the process can skip one or more of the steps. In other aspects, one or more of the steps are performed simultaneously. In some aspects, additional steps can be performed.

One or more embodiments of the disclosure provide improved methods, apparatus and computer program products for biometric recognition using mask-based generation of residual images. The foregoing applications and associated embodiments should be considered as illustrative only, and numerous other embodiments can be configured using the techniques disclosed herein, in a wide variety of different applications.

In one or more embodiments, the disclosed techniques for biometric recognition using mask-based generation of residual images may employ an adaptive feature disguise that dynamically adjusts high-dimensional data (e.g., facial features) in a manner that is unique to each session, for example to enhance privacy and significantly reducing a risk of unauthorized data recovery and spoofing attacks. One or more embodiments may incorporate random channel shuffling to introduce unpredictability in the data, where the pattern of shuffling changes randomly, making it virtually impossible for unauthorized entities to reverse-engineer or recover the original facial image data, for example. An optimized processing framework is provided in some embodiments that maintains algorithmic performance even on hardware with limited computational capabilities. In this manner, the disclosed techniques for biometric recognition using mask-based generation of residual images may be deployed on a wide range of devices, ensuring that user privacy is protected without sacrificing convenience or performance.

It should also be understood that the disclosed techniques for biometric recognition using mask-based generation of residual images, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for biometric recognition using mask-based generation of residual images may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute and/or storage services can be offered to cloud infrastructure tenants or other system users as a Platform-as-a-Service (PaaS) model, an Infrastructure-as-a-Service (IaaS) model, a Storage-as-a-Service (STaaS) model and/or a Function-as-a-Service (FaaS) model, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based mask-based image subtraction engine, or portions thereof, are illustratively implemented for use by tenants of such a multi-tenant environment.

Cloud infrastructure as disclosed herein can include cloud-based systems. Virtual machines provided in such systems can be used to implement at least portions of a cloud-based mask-based image subtraction platform in illustrative embodiments. The cloud-based systems can include object stores.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

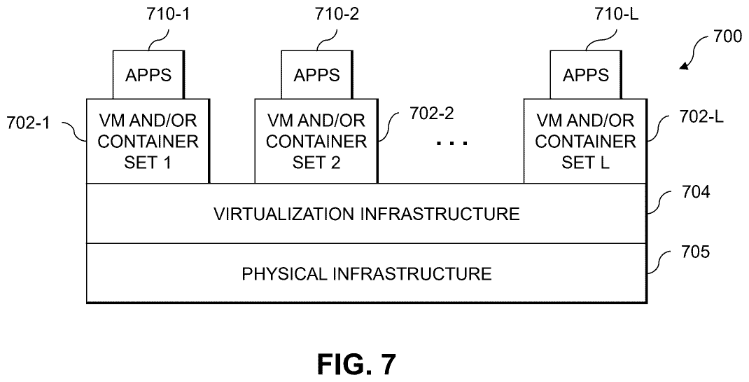

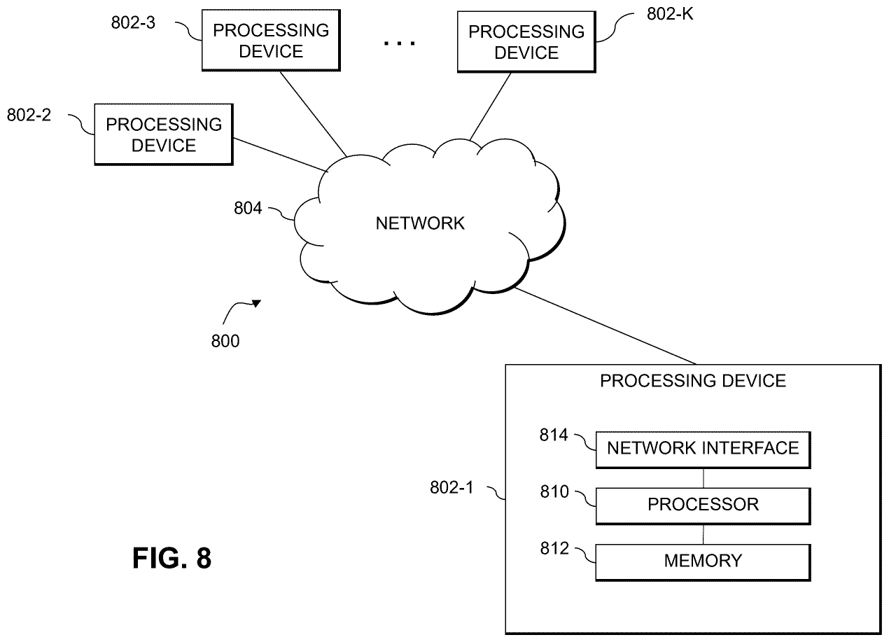

Illustrative embodiments of processing platforms will now be described in greater detail with reference to FIGS. 7 and 8. These platforms may also be used to implement at least portions of other information processing systems in other embodiments.

FIG. 7 shows an example processing platform comprising cloud infrastructure 700. The cloud infrastructure 700 comprises a combination of physical and virtual processing resources that may be utilized to implement at least a portion of the information processing system 70. The cloud infrastructure 700 comprises multiple virtual machines (VMs) and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 may comprise respective VMs, respective sets of one or more containers, or respective sets of one or more containers running in VMs.

In some implementations of the FIG. 7 embodiment, the VMs/container sets 702 comprise respective VMs implemented using virtualization infrastructure 704 that comprises at least one hypervisor. Such implementations can provide chat assistant adaptation functionality of the type described above for one or more processes running on a given one of the VMs. For example, each of the VMs can implement control logic for mask-based generation of residual images and associated functionality for performing biometric recognition using a residual image.

An example of a hypervisor platform that may be used to implement a hypervisor within the virtualization infrastructure 704 is a compute virtualization platform which may have an associated virtual infrastructure management system such as server management software. The underlying physical machines may comprise one or more distributed processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system. Such implementations can provide chat assistant adaptation functionality of the type described above for one or more processes running on different ones of the containers. For example, a container host device supporting multiple containers of one or more container sets can implement one or more instances of control logic for mask-based generation of residual images and associated functionality for performing biometric recognition using a residual image.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises at least a portion of the given system and includes a plurality of processing devices, denoted 802-1, 802-2, 802-3, . . . 802-K, which communicate with one another over a network 804. The network 804 may comprise any type of network, such as a WAN, a LAN, a satellite network, a telephone or cable network, a cellular network, a wireless network such as WiFi or WiMAX, or various portions or combinations of these and other types of networks.

The processing device 802-1 in the processing platform 800 comprises a processor 810 coupled to a memory 812. The processor 810 may comprise a microprocessor, a microcontroller, an ASIC, an FPGA, a CPU, a GPU, a TPU, a VPU, an NPU, a DPU, an SOC or other type of processing circuitry, as well as portions or combinations of such circuitry elements, and the memory 812, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 7 or 8, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
encoding at least a portion of at least one image of a user to obtain a multi-dimensional representation of the image;
generating at least one mask identifying one or more sub-regions of the image;
generating a residual image utilizing a transformation function that processes the multi-dimensional representation of the image, the mask and at least one noise vector;
applying the residual image to a recognition model to determine a recognition result; and
controlling a performance of at least one automated action based at least in part on the recognition result;
wherein the method is performed by at least one processing device comprising a processor coupled to a memory.

2. The computer-implemented method of claim 1, wherein the transformation function determines a difference between the multi-dimensional representation of the image within the one or more sub-regions, identified by the mask, and at least a portion of the at least one noise vector.

3. The computer-implemented method of claim 1, wherein the multi-dimensional representation of the image comprises a plurality of pixels, each comprising a plurality of channels, and further comprising adjusting an order of the plurality of channels for at least one pixel of the plurality of pixels prior to applying the multi-dimensional representation of the image to the transformation function.

4. The computer-implemented method of claim 3, wherein the adjusting the order of the plurality of channels is based at least in part on a permutation value that is dynamically selected for each user session.

5. The computer-implemented method of claim 3, further comprising restoring an order of the plurality of channels prior to the applying the residual image to the recognition model.

6. The computer-implemented method of claim 1, wherein the mask is generated using a privacy-preserving model that increases an entropy of the one or more sub-regions of the image.

7. The computer-implemented method of claim 6, further comprising reducing a number of bits used to encode one or more model weights of one or more of the recognition model and the privacy-preserving model.

8. The computer-implemented method of claim 6, further comprising pruning one or more model weights, having a significance value below a designated threshold value, of one or more of the recognition model and the privacy-preserving model.

9. The computer-implemented method of claim 6, further comprising decomposing at least one model weight matrix, of one or more of the recognition model and the privacy-preserving model, into a plurality of sub-matrices, wherein the plurality of sub-matrices comprises a diagonal matrix, and further comprising reducing a dimensionality of the diagonal matrix by removing one or more model weights from the diagonal matrix.

10. The computer-implemented method of claim 6, further comprising performing at least one matrix multiplication using at least one algorithm, of a plurality of algorithms, having a reduced computational complexity, relative to at least one additional algorithm in the plurality of algorithms, by performing a reduced number of the matrix operations.

11. A non-transitory processor-readable storage medium having stored therein program code of one or more software programs, wherein the program code when executed by at least one processing device causes the at least one processing device:
encoding at least a portion of at least one image of a user to obtain a multi-dimensional representation of the image;
generating at least one mask identifying one or more sub-regions of the image;
generating a residual image utilizing a transformation function that processes the multi-dimensional representation of the image, the mask and at least one noise vector;
applying the residual image to a recognition model to determine a recognition result; and
controlling a performance of at least one automated action based at least in part on the recognition result.

12. The non-transitory processor-readable storage medium of claim 11, wherein the transformation function determines a difference between the multi-dimensional representation of the image within the one or more sub-regions, identified by the mask, and at least a portion of the at least one noise vector.

13. The non-transitory processor-readable storage medium of claim 11, wherein the multi-dimensional representation of the image comprises a plurality of pixels, each comprising a plurality of channels, and further comprising adjusting an order of the plurality of channels for at least one pixel of the plurality of pixels prior to applying the multi-dimensional representation of the image to the transformation function.

14. The non-transitory processor-readable storage medium of claim 13, further comprising restoring an order of the plurality of channels prior to the applying the residual image to the recognition model.

15. The non-transitory processor-readable storage medium of claim 11, wherein the mask is generated using a privacy-preserving model that increases an entropy of the one or more sub-regions of the image, and further comprising one or more of: reducing a number of bits used to encode one or more model weights of one or more of the recognition model and the privacy-preserving model; pruning one or more model weights, having a significance value below a designated threshold value, of one or more of the recognition model and the privacy-preserving model; decomposing at least one model weight matrix, of one or more of the recognition model and the privacy-preserving model, into a plurality of sub-matrices, wherein the plurality of sub-matrices comprises a diagonal matrix, and further comprising reducing a dimensionality of the diagonal matrix by removing one or more model weights from the diagonal matrix; and performing at least one matrix multiplication using at least one algorithm, of a plurality of algorithms, having a reduced computational complexity, relative to at least one additional algorithm in the plurality of algorithms, by performing a reduced number of the matrix operations.

16. An apparatus comprising:
at least one processing device comprising a processor coupled to a memory;
the at least one processing device being configured:
encoding at least a portion of at least one image of a user to obtain a multi-dimensional representation of the image;
generating at least one mask identifying one or more sub-regions of the image;
generating a residual image utilizing a transformation function that processes the multi-dimensional representation of the image, the mask and at least one noise vector;
applying the residual image to a recognition model to determine a recognition result; and
controlling a performance of at least one automated action based at least in part on the recognition result.

17. The apparatus of claim 16, wherein the transformation function determines a difference between the multi-dimensional representation of the image within the one or more sub-regions, identified by the mask, and at least a portion of the at least one noise vector.

18. The apparatus of claim 16, wherein the multi-dimensional representation of the image comprises a plurality of pixels, each comprising a plurality of channels, and further comprising adjusting an order of the plurality of channels for at least one pixel of the plurality of pixels prior to applying the multi-dimensional representation of the image to the transformation function.

19. The apparatus of claim 18, further comprising restoring an order of the plurality of channels prior to the applying the residual image to the recognition model.

20. The apparatus of claim 16, wherein the mask is generated using a privacy-preserving model that increases an entropy of the one or more sub-regions of the image, and further comprising one or more of: reducing a number of bits used to encode one or more model weights of one or more of the recognition model and the privacy-preserving model; pruning one or more model weights, having a significance value below a designated threshold value, of one or more of the recognition model and the privacy-preserving model; decomposing at least one model weight matrix, of one or more of the recognition model and the privacy-preserving model, into a plurality of sub-matrices, wherein the plurality of sub-matrices comprises a diagonal matrix, and further comprising reducing a dimensionality of the diagonal matrix by removing one or more model weights from the diagonal matrix; and performing at least one matrix multiplication using at least one algorithm, of a plurality of algorithms, having a reduced computational complexity, relative to at least one additional algorithm in the plurality of algorithms, by performing a reduced number of the matrix operations.
